(19) United States
(12) Patent Application Publication
(10) Pub. No.: US 2025/0374093 A1
(43) Pub. Date: Dec. 4, 2025

(54) TECHNIQUES FOR ARTIFICIAL INTELLIGENCE (AI)-BASED REFERENCE SIGNAL (RS) PROCESSING USING MULTIPLE RS DENSITIES

(71) Applicant: QUALCOMM Incorporated, San Diego, CA (US)

(72) Inventors: Rui HU, Beijing (CN); Chenxi HAO, Beijing (CN); Chao WEI, Beijing (CN); Hao XU, Beijing (CN); Taesang YOO, San Diego, CA (US)

(21) Appl. No.: 18/876,170

(22) PCT Filed: Sep. 2, 2022
(86) PCT No.: PCT/CN2022/116748

§ 371 Date: Dec. 17, 2024

(51) Int. Cl. H04W 24/08; H04L 5/00; H04W 72/232

(52) U.S. Cl. CPC H04W 24/08; H04L 5/0048; H04W 72/232

(57) ABSTRACT

Aspects described herein relate to performing first signal measurements of reference signals (RSs) received over a first set of one or more RS occasions based on a first RS density, performing second signal measurements of RSs received over a second set of RS occasions based on a second RS density, and providing the first signal measurements identified as a first type of signal measurements and the second signal measurements identified as a second type of signal measurements for training a neural network, such as for channel state information reference signal (CSI-RS) transmission or channel estimation.

### FIELD OF THE DISCLOSURE

Aspects of the present disclosure relate generally to wireless communication systems, and more particularly, to techniques for performing artificial intelligence (AI)-based reference signal (RS) processing.

### DESCRIPTION OF RELATED ART

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, an apparatus for wireless communication is provided that includes a processor, memory coupled with the processor, and instructions stored in the memory. The instructions are operable, when executed by the processor, to cause the apparatus to receive a configuration indicating reference signal (RS) resources including at least a first set of one or more RS occasions of a first RS density and a second set of one or more RS occasions of a second RS density, perform first signal measurements of RSs received over the first set of one or more RS occasions, perform second signal measurements of RSs received over the second set of RS occasions, and provide the first signal measurements identified as a first type of signal measurements and the second signal measurements identified as a second type of signal measurements for training a neural network for channel state information reference signal (CSI-RS) transmission or channel estimation.

In another aspect, an apparatus for wireless communication is provided that includes a processor, memory coupled with the processor, and instructions stored in the memory. The instructions are operable, when executed by the processor, to cause the apparatus to transmit a configuration indicating RS resources including at least a first set of one or more RS occasions of a first RS density and a second set of one or more RS occasions of a second RS density, transmit the RS over the first set of one or more RS occasions, and transmit the RS over the second set of one or more RS occasions.

In another aspect, a method for wireless communication at a user equipment (UE) is provided that includes receiving a configuration indicating RS resources including at least a first set of one or more RS occasions of a first RS density and a second set of one or more RS occasions of a second RS density, performing first signal measurements of RSs received over the first set of one or more RS occasions, performing second signal measurements of RSs received over the second set of RS occasions, and providing the first signal measurements identified as a first type of signal measurements and the second signal measurements identified as a second type of signal measurements for training a neural network for CSI-RS transmission or channel estimation.

In another aspect, a method for wireless communication at a network node is provided that includes transmitting a configuration indicating RS resources including at least a first set of one or more RS occasions of a first RS density and a second set of one or more RS occasions of a second RS density, transmitting the RS over the first set of one or more RS occasions, and transmitting the RS over the second set of one or more RS occasions.

In other aspects, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a diagram illustrating an example of disaggregated base station architecture, in accordance with various aspects of the present disclosure;

FIG. 3 is a block diagram illustrating an example of a user equipment (UE) and a training entity, in accordance with various aspects of the present disclosure;

FIG. 4 is a block diagram illustrating an example of a base station, in accordance with various aspects of the present disclosure;

FIG. 5 is a flow chart illustrating an example of a method for measuring reference signals (RSs) signals having different RS densities, in accordance with aspects described herein;

FIG. 6 is a flow chart illustrating an example of a method for transmitting RSs having different RS densities, in accordance with aspects described herein;

FIG. 7 illustrates examples of timelines for RS density formats, in accordance with aspects described herein;

FIG. 8 is a flow chart illustrating an example of a method for training a neural network based on RSs transmitted according to different RS densities, in accordance with aspects described herein; and

FIG. 9 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to artificial intelligence (AI)- or machine learning (ML)-based reference signal (RS) processing using RSs that are transmitted at different resource densities. In AI- or ML-based RS processing (referred to herein as AI-based RS processing) can include joint training of RS and an associated neural network (NN) model between devices that communicate the RS or performing channel estimation based on the RS (e.g., between a gNB and user equipment (UE), between two UEs, etc.). In an example, joint training of channel state information (CSI)-RS and channel estimation NN can occur aiming to obtain decent channel estimation results but with reduced CSI-RS overhead. For example, the NN can be trained by minimizing a means-squared error (MSE) between a ground-truth channel, h, and a channel received with noise, ĥ. For example, a dataset of ground-truth channels used by a NN can be large and may have many parameters. Also, preparing a dataset for training can consume RSs (e.g., for CSI-RS optimizing, higher density CSI-RS can be used for obtaining ground-truth channels).

In an example, collecting real-world data can be important for application of AI/ML in wireless communication. Data can be collected before commercialization where the modem (e.g., channel estimation part, CSI engine part) maybe trained using data collected from test mobile, or after commercialization where collecting data is used for model retraining and fine-tuning. For AI-based RS optimization, one goal may be to reduce RS overhead. Obtaining the genie channel may not be possible, so the ground-truth can be collected from higher-density RS. Transmitting higher-density RS for data collection, however, can cause significant resource overhead by utilizing a large number of radio resources. Semi-supervised training can be used for AI-based RS optimization (overhead reduction). Some collected data can be based on higher density RS (which can be referred to as labeled data), and some collected data can based on lower density RS (which can be referred to as unlabeled data). The NN can be trained with both the labeled data and unlabeled data.

For example, RSs may be transmitted at a high density or low density, where the density may correspond to a spatial density between a number of resource elements (REs) occupied by the RS and a dimension of the channel in space, a frequency density between the number of resource blocks (RBs) occupied by the RS and a dimension of the channel bandwidth, or a time density of a number of shots per transmission occasion in time. Higher density RSs can provide for determining a ground-truth channel, while lower density RSs may not. RSs transmitted at both densities, however, can be used in training a neural network (NN) for AI-based RS processing, and the RSs used for training the NN can be indicated along with the density level to allow the NN to differentiate RSs that may represent ground-truth channel. A UE, for example, can be configured with information for determining the RSs to be used for data collection for the NN, along with the corresponding RS densities. In some examples, the UE may report a capability for supporting RSs of multiple densities. The UE can also upload data collected from the RSs to a device that trains the NN, and can indicate the RS density corresponding to the data.

Allowing the low density RSs to be used in training the NN can provide for additional datasets for the NN without sacrificing the radio resources required for the high density RSs to provide the ground-truth channel. This can improve performance of a UE receiving the RSs by enabling additional resources for communicating other data and/or can otherwise improve overall network efficiency and performance by decreasing resource utilization.

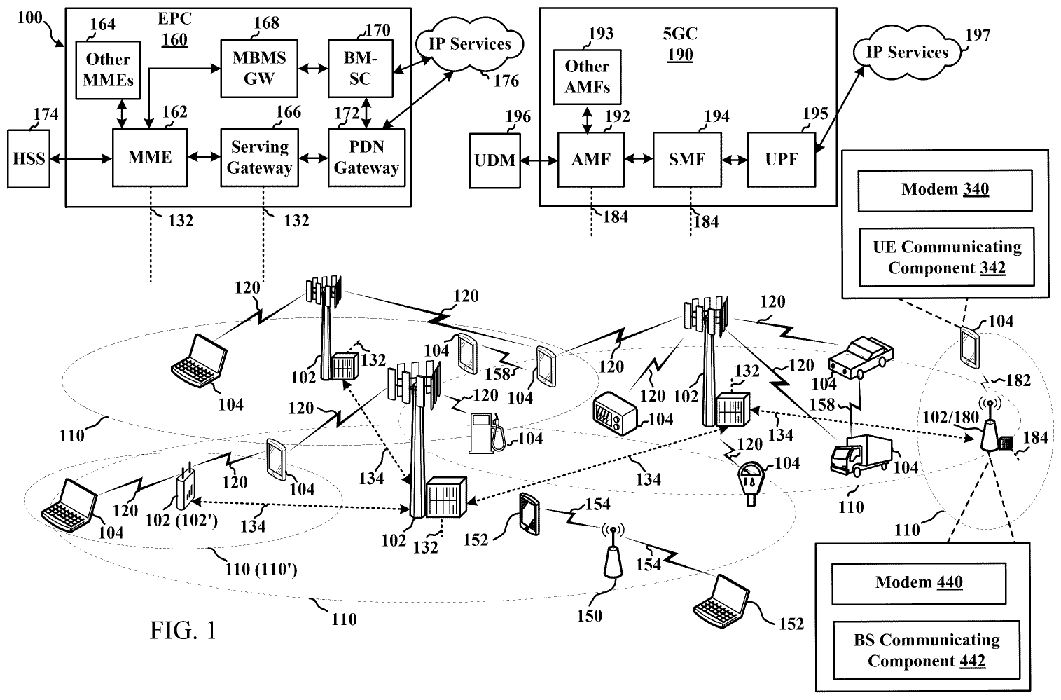

The described features will be presented in more detail below with reference to FIGS. 1-9.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 340 and UE communicating component 342 for receiving RSs at multiple RS densities, in accordance with aspects described herein. In addition, some nodes may have a modem 440 and a BS communicating component 442 for configuring a device to receive RSs at multiple RS densities, in accordance with aspects described herein. Though a UE 104 is shown as having the modem 340 and UE communicating component 342 and a base station 102/gNB 180 is shown as having the modem 440 and BS communicating component 442, this is one illustrative example, and substantially any node or type of node may include a modem 340 and UE communicating component 342 and/or a modem 440 and BS communicating component 442 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS, e.g., BS 102), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In an example, UE communicating component 342 can receive RSs at different RS densities, such as a first RS density that allows for obtaining a ground-truth channel (a high density) and a second density that corresponds to a less dense resource allocation than the high density (a low density). The UE communicating component 342 can differentiate between the RS densities when providing information regarding the RSs, such as RS strength or quality measurement, to a NN for training. This can allow the NN to use a larger dataset to train the NN, which can provide for a more robust NN to use for CSI-RS transmission, channel estimation based on the CSI-RS, etc. In an example, BS communicating component 442 can configure a device, such as a UE 104, to receive the RSs at different RS densities, activate or deactivate data collection based on the RSs at the device, and/or the like.

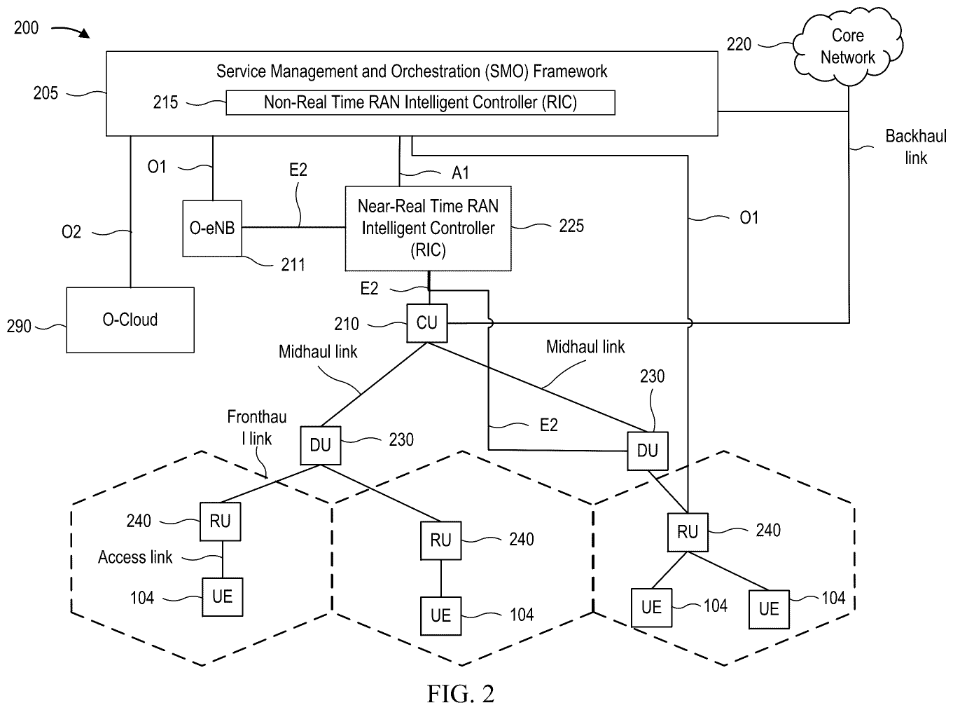

FIG. 2 shows a diagram illustrating an example of disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the third Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communication with one or more UEs 104. In some implementations, real-time and non-real-time aspects of control and user plane communication with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUS 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

In an example, BS communicating component 442, as described herein, can be at least partially implemented within one or more DUs 230 to configure a UE 104 for receiving RSs at different RS densities, transmitting the RSs at different RS densities, etc. In another example, BS communicating component 442, as described herein, can be at least partially implemented within one or more RUs 240 to configure a UE 104 for receiving RSs at different RS densities, transmitting the RSs at different RS densities, etc.

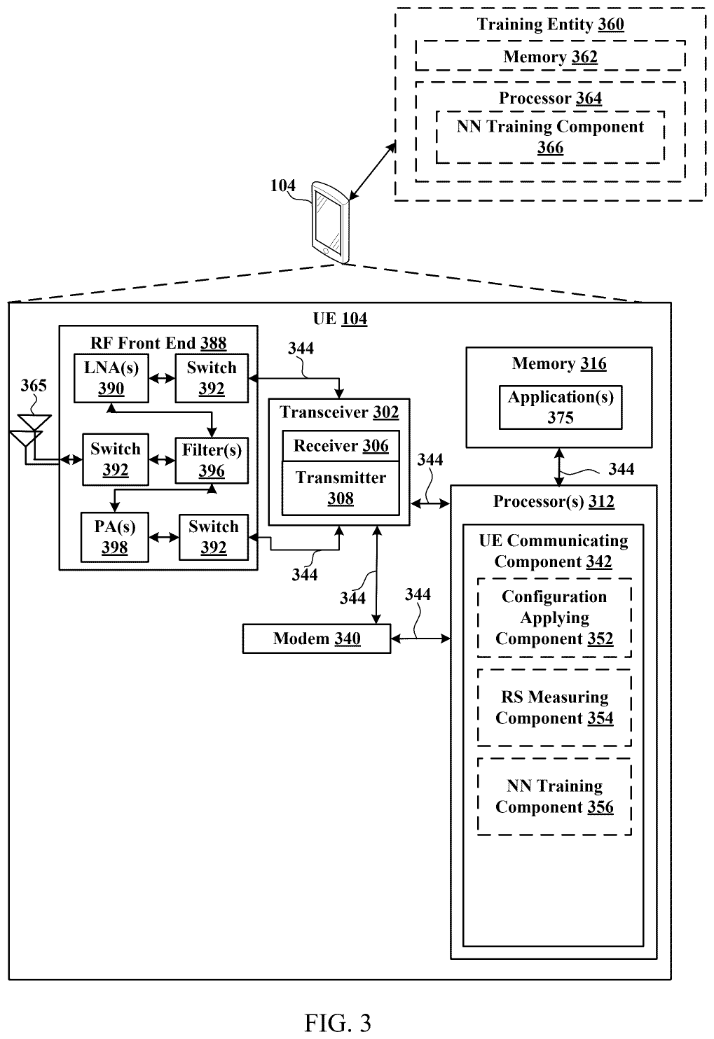

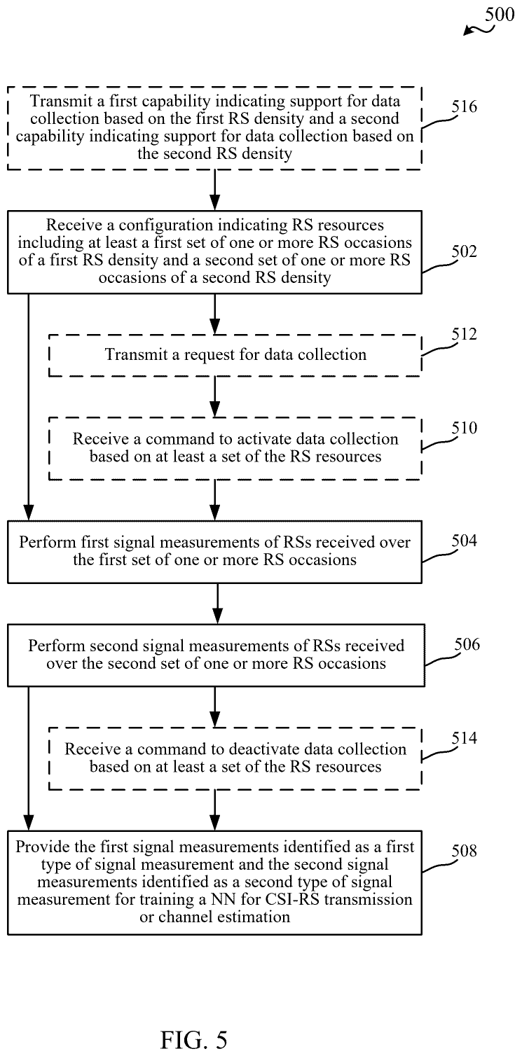

Turning now to FIGS. 3-9, aspects are depicted with reference to one or more components and one or more methods that may perform the actions or operations described herein, where aspects in dashed line may be optional. Although the operations described below in FIGS. 5-7 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 3, one example of an implementation of UE 104 may include a variety of components, some of which have already been described above and are described further herein, including components such as one or more processors 312 and memory 316 and transceiver 302 in communication via one or more buses 344, which may operate in conjunction with modem 340 and/or UE communicating component 342 for receiving RSs at multiple RS densities, in accordance with aspects described herein.

In an aspect, the one or more processors 312 can include a modem 340 and/or can be part of the modem 340 that uses one or more modem processors. Thus, the various functions related to UE communicating component 342 may be included in modem 340 and/or processors 312 and, in an aspect, can be executed by a single processor, while in other aspects, different ones of the functions may be executed by a combination of two or more different processors. For example, in an aspect, the one or more processors 312 may include any one or any combination of a modem processor, or a baseband processor, or a digital signal processor, or a transmit processor, or a receiver processor, or a transceiver processor associated with transceiver 302. In other aspects, some of the features of the one or more processors 312 and/or modem 340 associated with UE communicating component 342 may be performed by transceiver 302.

Also, memory 316 may be configured to store data used herein and/or local versions of applications 375 or UE communicating component 342 and/or one or more of its subcomponents being executed by at least one processor 312. Memory 316 can include any type of computer-readable medium usable by a computer or at least one processor 312, such as random access memory (RAM), read only memory (ROM), tapes, magnetic discs, optical discs, volatile memory, non-volatile memory, and any combination thereof. In an aspect, for example, memory 316 may be a non-transitory computer-readable storage medium that stores one or more computer-executable codes defining UE communicating component 342 and/or one or more of its subcomponents, and/or data associated therewith, when UE 104 is operating at least one processor 312 to execute UE communicating component 342 and/or one or more of its subcomponents.

Transceiver 302 may include at least one receiver 306 and at least one transmitter 308. Receiver 306 may include hardware, firmware, and/or software code executable by a processor for receiving data, the code comprising instructions and being stored in a memory (e.g., computer-readable medium). Receiver 306 may be, for example, a radio frequency (RF) receiver. In an aspect, receiver 306 may receive signals transmitted by at least one base station 102. Additionally, receiver 306 may process such received signals, and also may obtain measurements of the signals, such as, but not limited to, Ec/Io, signal-to-noise ratio (SNR), signal-to-interference-and-noise ratio (SINR), reference signal received power (RSRP), reference signal received quality (RSRQ), received signal strength indicator (RSSI), etc. Transmitter 308 may include hardware, firmware, and/or software code executable by a processor for transmitting data, the code comprising instructions and being stored in a memory (e.g., computer-readable medium). A suitable example of transmitter 308 may including, but is not limited to, an RF transmitter.

Moreover, in an aspect, UE 104 may include RF front end 388, which may operate in communication with one or more antennas 365 and transceiver 302 for receiving and transmitting radio transmissions, for example, wireless communications transmitted by at least one base station 102 or wireless transmissions transmitted by UE 104. RF front end 388 may be connected to one or more antennas 365 and can include one or more low-noise amplifiers (LNAs) 390, one or more switches 392, one or more power amplifiers (PAs) 398, and one or more filters 396 for transmitting and receiving RF signals.

In an aspect, LNA 390 can amplify a received signal at a desired output level. In an aspect, each LNA 390 may have a specified minimum and maximum gain values. In an aspect, RF front end 388 may use one or more switches 392 to select a particular LNA 390 and its specified gain value based on a desired gain value for a particular application.

Further, for example, one or more PA(s) 398 may be used by RF front end 388 to amplify a signal for an RF output at a desired output power level. In an aspect, each PA 398 may have specified minimum and maximum gain values. In an aspect, RF front end 388 may use one or more switches 392 to select a particular PA 398 and its specified gain value based on a desired gain value for a particular application.

Also, for example, one or more filters 396 can be used by RF front end 388 to filter a received signal to obtain an input RF signal. Similarly, in an aspect, for example, a respective filter 396 can be used to filter an output from a respective PA 398 to produce an output signal for transmission. In an aspect, each filter 396 can be connected to a specific LNA 390 and/or PA 398. In an aspect, RF front end 388 can use one or more switches 392 to select a transmit or receive path using a specified filter 396, LNA 390, and/or PA 398, based on a configuration as specified by transceiver 302 and/or processor 312.

As such, transceiver 302 may be configured to transmit and receive wireless signals through one or more antennas 365 via RF front end 388. In an aspect, transceiver may be tuned to operate at specified frequencies such that UE 104 can communicate with, for example, one or more base stations 102 or one or more cells associated with one or more base stations 102. In an aspect, for example, modem 340 can configure transceiver 302 to operate at a specified frequency and power level based on the UE configuration of the UE 104 and the communication protocol used by modem 340.

In an aspect, modem 340 can be a multiband-multimode modem, which can process digital data and communicate with transceiver 302 such that the digital data is sent and received using transceiver 302. In an aspect, modem 340 can be multiband and be configured to support multiple frequency bands for a specific communications protocol. In an aspect, modem 340 can be multimode and be configured to support multiple operating networks and communications protocols. In an aspect, modem 340 can control one or more components of UE 104 (e.g., RF front end 388, transceiver 302) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 342 can optionally include a configuration applying component 352 for applying a configuration at the UE 104, such as a configuration indicating RSs to measure at multiple RS densities for data collection for training a NN, a RS measuring component 354 for measuring RSs received at multiple RS densities, and/or a NN training component 356 for providing the RS measurements, along with an indication associated with the corresponding RS density, for training a NN, in accordance with aspects described herein.

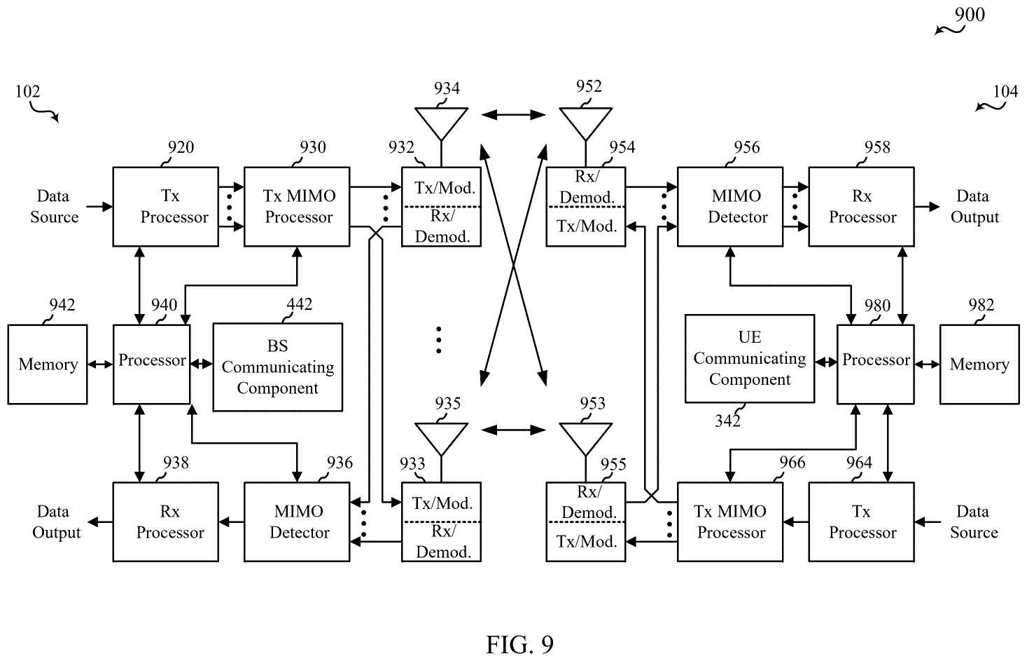

In an aspect, the processor(s) 312 may correspond to one or more of the processors described in connection with the UE in FIG. 9. Similarly, the memory 316 may correspond to the memory described in connection with the UE in FIG. 9.

In an example, the UE 104 can optionally communicate with a training entity 360 that may include the NN training component 366. For example, training entity 360 may be a node in the wireless network with which the UE 104 can communicate via one or more network nodes (e.g., via one or more base stations), such as a UE server. The training entity 360 may be part of the core network (e.g., EPC 160 or 5GC 190) or provided by a node of the core network. The training entity 360 can also include a memory 362, similar to memory 316, that can store data or instructions for performing functionalities of the NN training component 366. The training entity 360 can also include a processor 364, similar to processor 312, for performing functions of the NN training component 366. In an example, NN training component 356 of the UE 104 can provide signal measurements and/or associated data to NN training component 366 of the training entity 360 to allow the training entity 360 to train the NN, which can relieve the UE 104 of processing burden or can also provide benefit of associating data sets from multiple UEs in training the NN.

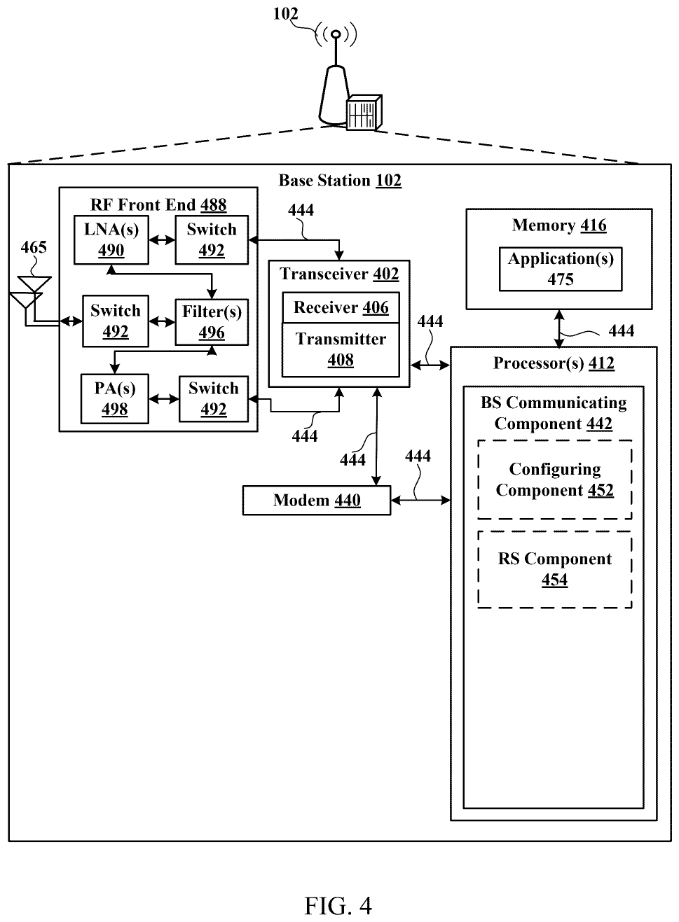

Referring to FIG. 4, one example of an implementation of base station 102 (e.g., a base station 102 and/or gNB 180, as described above) may include a variety of components, some of which have already been described above, but including components such as one or more processors 412 and memory 416 and transceiver 402 in communication via one or more buses 444, which may operate in conjunction with modem 440 and a BS communicating component 442 for configuring a device to receive RSs at multiple RS densities, in accordance with aspects described herein.

The transceiver 402, receiver 406, transmitter 408, one or more processors 412, memory 416, applications 475, buses 444, RF front end 488, LNAs 490, switches 492, filters 496, PAs 498, and one or more antennas 465 may be the same as or similar to the corresponding components of UE 104, as described above, but configured or otherwise programmed for base station operations as opposed to UE operations.

In an aspect, BS communicating component 442 can optionally include a configuring component 452 for configuring a UE 104 with a configuration indicating RSs to measure at multiple RS densities for data collection for training a NN, and/or a RS component 454 for transmitting RSs at multiple RS densities, in accordance with aspects described herein.

In an aspect, the processor(s) 412 may correspond to one or more of the processors described in connection with the base station in FIG. 9. Similarly, the memory 416 may correspond to the memory described in connection with the base station in FIG. 9.

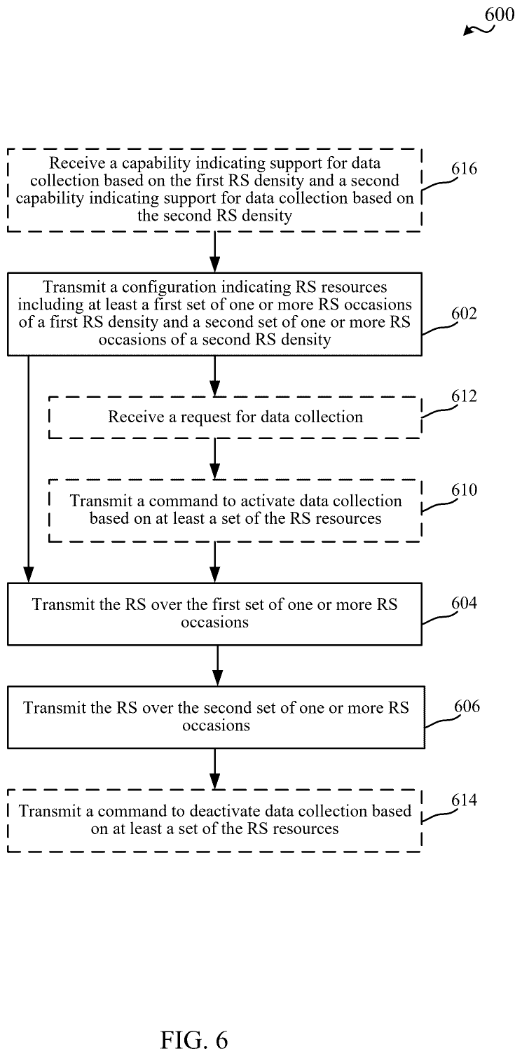

FIG. 5 illustrates a flow chart of an example of a method 500 for measuring RSs having different RS densities, in accordance with aspects described herein. FIG. 6 illustrates a flow chart of an example of a method 600 for transmitting RSs having different RS densities, in accordance with aspects described herein. In an example, a UE 104 can perform the functions described in method 500 using one or more of the components described in FIGS. 1 and 3. In an example, a network node, such as a base station 102, a gNB, a monolithic base station or gNB, a portion of a disaggregated base station or gNB, etc.) can perform the functions described in method 600 using one or more of the components described in FIGS. 1 and 4. Methods 500 and 600 are described in conjunction with one another for case of explanation; however, the methods 500 and 600 are not required to be performed together and indeed can be performed independently using separate devices.

In method 600, at Block 602, a configuration indicating RS resources including at least a first set of one or more RS occasions of a first RS density and a second set of one or more RS occasions at a second RS density can be transmitted. In an aspect, configuring component 452, e.g., in conjunction with processor(s) 412, memory 416, transceiver 402, BS communicating component 442, etc., can transmit the configuration indicating RS resources including at least a first set of one or more RS occasions of a first RS density and a second set of one or more RS occasions at a second RS density. For example, configuring component 452 can transmit the configuration to one or more UEs using radio resource control (RRC) signaling, media access control (MAC)-control element (CE), downlink control information (DCI), etc. The configuration may indicate one or more parameters that allow the UEs to determine resources over which the receive RSs at different RS densities, such as a high density and low density, and/or other densities.

In method 500, at Block 502, a configuration indicating RS resources including at least a first set of one or more RS occasions of a first RS density and a second set of one or more RS occasions at a second RS density can be received. In an aspect, configuration applying component 352, e.g., in conjunction with processor(s) 312, memory 316, transceiver 302, UE communicating component 342, etc., can receive and/or apply the configuration indicating RS resources including at least a first set of one or more RS occasions of a first RS density and a second set of one or more RS occasions at a second RS density. For example, configuration applying component 352 can receive the configuration in RRC signaling, MAC-CE, DCI, etc. from a network node (e.g., a base station 102 or gNB, a disaggregated portion thereof, etc.), another UE, or other device. For example, configuration applying component 352 can apply the configuration at the UE 104 for determine resources over which to receive RSs at various RS densities.

As described, for example, the RS density can correspond to a spatial RS density, such as a relation between the number of REs occupied by the RS and a dimension of the channel in space. For example, where a number of antennas/ports used to transmit the RS is Nₜ, and the number of REs occupied by the RS is L, then L<Nₜ can correspond to spatial lower density RS and L=Nₜ can correspond to spatial higher density RS. In another example, the RS density can correspond to a frequency RS density, such as a relation between the number of RBs occupied by the RS and a dimension of the channel bandwidth. For example, where the channel bandwidth is N_{RB}, and the number of RBs occupied by the RS is K, then K<N_{RB} can correspond to frequency lower density RS and K=N_{RB} can correspond to frequency higher density RS. In another example, the RS density can correspond to a time RS density, such as a relation between the number of shots per transmission occasion. For example, a shot can correspond to one transmission in a burst or transmissions, which may occur over multiple consecutive symbols (e.g., orthogonal frequency division multiplexing (OFDM) symbols, single carrier-frequency division multiplexing (SC-FDM) symbols, etc.), over multiple slots of multiple symbols, etc. For example, where the total allowable shots per transmission occasion is S, and the number of transmitted shots is M, then M<S can correspond to time lower density RS and M=S can correspond to time higher density RS.

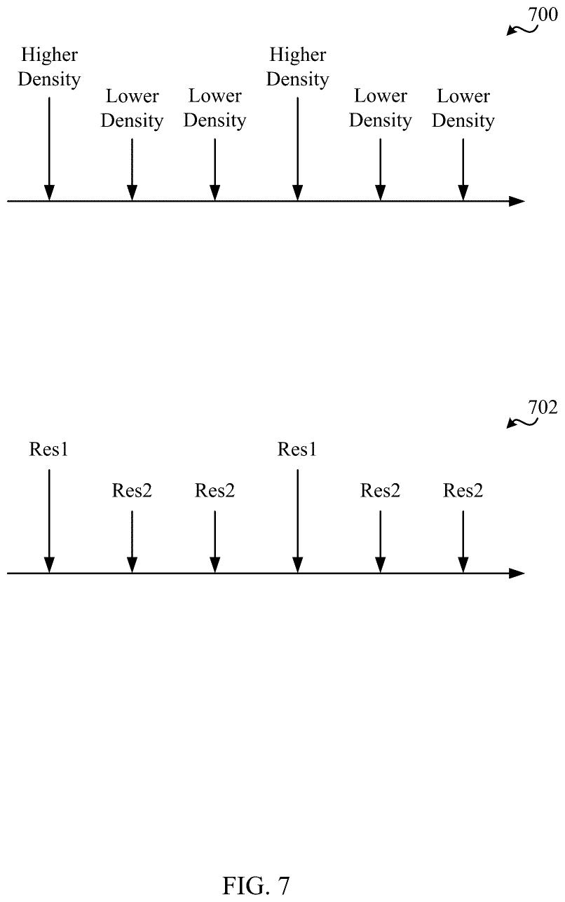

In an example, the configuration can include one or more of various possible formats or associated parameters to indicate resources for the RSs of multiple RS densities. FIG. 7 illustrates examples of timelines 700, 702 for RS density formats. In one example, the configuration can indicate a single resource, where some RSs have higher density occasions (e.g., labeled RS) and some other have lower density occasions (unlabeled RS). An example is shown in timeline 700 including a single RS resource having higher density and lower density RSs that are transmitted over a period of time. The configuration can accordingly indicate, for a given RS resource, an indication of the higher density and the lower density, which may include, for each density, an indication of a time instance or period (e.g., a periodicity) over which the RSs of that density are transmitted. In another example, the configuration can indicate combined (or paired) resources where one resource has higher density and the other resource has lower density, where the higher density resource may or may not have a longer periodicity. An example, is shown in timeline 702 where multiple RS resources are defined, including Res1 and Res2. The configuration can indicate these resources as combined (or paired), such as for the purpose of indicating common information for the RSs transmitted at the different RS densities. In yet another example, the configuration can indicate non-paired resources, such that the network node can separately configure and/or trigger data collection based on different density RSs (e.g., higher, lower, etc.).

For example, where the configuration indicates the single resource with a first set of one or more RS occasions at a first RS density, and a second set of one or more RS occasions at a second RS density (e.g., such as in the timeline 700 in FIG. 7), the configuration may include various parameters to configure the RSs for data collection. In this example, the configuration may indicate a component carrier (CC) identifier or cell identifier to which the RS relates, a list of one or more RS resources (e.g., CSI-RS resources), and/or additional information for each RS resource. For example, for each RS resource, the configuration may also indicate a time domain type, such as periodic or semi-persistent, along with associated parameters for indicating the time period over which the associated RSs are transmitted, such as a period for a periodic type, an indication of time resources for semi-persistent type, etc. The configuration may include this information for each RS density configured for the given RS resource, such as a first periodicity and/or offset configuration for a first RS density (e.g., high density), a second periodicity and/or offset configuration for a second RS density (e.g., low density), etc. In an example, configuration applying component 352 can use this information to determine the time periods for receiving the RSs at the various RS densities.

In addition, in this example, for each RS resource, the configuration can include a resource pattern/mapping configuration, in frequency, for one or more RS densities. For example, for high density, a current CSI-RS pattern can be assumed, such as a CSI-RS pattern defined in a wireless communication technology, such as 5G NR. This resource pattern can include multiple consecutive REs for each of multiple antenna ports in multiple consecutive resource blocks in a symbol used for CSI-RS. For example, configuration applying component 352 can determine the pattern for the high density RS based on the CSI-RS pattern identified in a configuration for CSI-RS as received by the network node. For low density, the configuration may indicate a cover code identifier that indicates a NN-based cover-code that can be used to determine the RBs, REs, etc. corresponding to the low density CSI-RS. For example, configuration applying component 352 can determine the pattern for the low density RS based on the cover code identifier, which can indicate the frequency resources for the low density RS. In another example, for low density, the configuration may indicate a legacy pattern defined for CSI-RS with a lower number of antenna ports than are configured by the network node (and thus using less RBs than the full CSI-RS pattern). In this example, the actual transmitted ports on each RB can be different following a rule based on {N1, N2, L}, where N1 and N2 can define the dimensions of the antenna array at the network node, and L can define a number of layers of the antenna arrays at the network node. The rule for mapping the ports to the legacy pattern using the lower number of ports can be configured at the UE 104 by the network node or based on a wireless communication technology standard, such as 5G NR, etc. For example, configuration applying component 352 can determine the pattern for the low density RS by applying the antenna ports of the network node to the legacy CSI-RS pattern based on the rule.

In yet another example, to define the RS frequency pattern for each RS resource, the configuration can include or indicate a resource pattern/mapping configuration for the high density RS (e.g., the full density CSI-RS pattern, such as defined in 5G NR), and a muting pattern for the low density RS that is based on the pattern for the high density RS. In one example, the lower density pattern can be obtained by muting a few REs on each RB or muting a few CSI-RS shots (in one example, multiple shots per transmission occasion). The muted REs can be different across RBs. For example, the muting can be applied for all ports (e.g., all ports can have frequency low density CSI-RS, as described above) and the same or different REs can be muted for different ports, such that different ports can be transmitted on same or different RBs. In another example, the muting can be applied for a portion of ports, e.g., only the muted ports can have frequency low density CSI-RS and the remaining ports can have frequency full-density CSI-RS. In yet another example, some ports can be completely muted (e.g., no CSI-RS transmission on these ports), and the remaining ports can have frequency low density or frequency full density CSI-RS. In an example, configuration applying component 352 can determine the pattern for the high density RS based on an identifier configured for full-density CSI-RS, as defined in 5G NR for example, as described, and can determine the pattern for the low density RS by applying the muting pattern to the pattern configured for the high density RS.

For example, configuration applying component 352 can determine the frequency resources (e.g., RBs) or time resources (e.g., shots) for the low density RS based on parameters in the configuration indicating how to apply the muting pattern and determining the resources that are not muted for the low density RS. For example, where the configuration indicates which REs are muted, configuration applying component 352 can determine how to map remaining REs to different ports (e.g., map remaining REs for all ports, a portion of the ports, or refrain from mapping any remining REs to certain ports, as described above).

In this example, the configuration can also indicate, for each RS resource, quasi-colocation (QCL) information, which may indicate a transmission configuration indicator (TCI) state corresponding to a beam used to transmit, or a beam to be used to receive, the RS. In addition, in this example, the configuration can also indicate, for each RS resource, bandwidth part (BWP) information indicating a BWP over which the RS is transmitted. In addition, in this example, the configuration can also indicate metadata information including antenna layout at the network node used to transmit the RS, antenna element to transceiver unit (TxRU) mapping, digital-to-analog precoding, etc. In one example, the metadata information may relate to an identifier, and the configuration can indicate the identifier for the relevant metadata information for the RS resource. In an example, the UE 104 can provide or use the metadata information in training the NN, as described herein. In an example, configuration applying component 352 can obtain the QCL information, BWP information, metadata information, etc., and can use the information to receive the RS and/or report measurement of the RS for NN training. In an example, the configuration may also indicate a data collection configuration identifier, which can be subsequently used to activate data collection based on the configuration (e.g., in a received MAC-CE or DCI).

For example, where the configuration indicates combined (or paired) resources (or resource sets) where one resource has higher density and the other resource has lower density, the resources (or resource sets) can be combined for the purposes of configuring the same parameters for the combined resources (or resource sets). In one example, the configuration can indicate a one-to-one mapping between the resources (or resource sets), where the resources (or resource sets) can each correspond to a set of one or more RS occasions associated with different RS densities. In this example, each RS resource (or resource set) can be separately indicated, and a pairing or combination indication can be provided in the configuration to identify which RS resources (or resource sets) are combined. For example, the configuration can indicate, for combined resources, the same CC or cell identifier, the same QCL information, the same BWP information, the same metadata information (or corresponding identifier), etc., as described above. The resources, however, can have independently configured resource pattern/mapping configurations. For example, as described above, resources for high RS density (e.g., labeled data collection) can have full density and longer periodicity than resources for low RS density (e.g., unlabeled data collection).

In this example, for low RS density, the configuration can indicate resource mapping using a cover-code identifier that corresponds to a NN-based cover-code, a legacy CSI-RS pattern with fewer number of ports where actual transmitted ports on each RB can be different following a rule based on {N1, N2, L}, etc., as described above. In addition, for example, the configuration can include a data collection configuration identifier per RS resource, as described above. For example, configuration applying component 352 can accordingly determine and process the indication of resources and/or other information for the RS resources, as described above, where some of the information between combined resources can be the same or otherwise shared in the configuration. Configuration applying component 352 can accordingly determine the information common to the RS resources and the corresponding RS occasions over which RSs are transmitted for each RS density.

For example, where the configuration indicates non-paired resources, the configuration can include separate resource indications and corresponding information (e.g., CC or cell ID, QCL, BWP, metadata, etc.) for each resource. For example, configuration applying component 352 can accordingly determine and process the indication of resources and/or other information for each RS resource as separately indicated in the configuration. Configuration applying component 352 can accordingly determine the information for each RS resource, along with the RS occasions over which RS is transmitted.

The network node can transmit, and/or the UE can receive, the RSs based on the configured resources and RS densities. For example, in method 600, at Block 604, the RS can be transmitted over the first set of one or more RS occasions, and at Block 606, the RS can be transmitted over the second set of RS occasions. In an aspect, RS component 454, e.g., in conjunction with processor(s) 412, memory 416, transceiver 402, BS communicating component 442, etc., can transmit the RS over the first set of one or more RS occasions and/or can transmit the RS over the second set of one or more RS occasions such to transmit the RS at the corresponding different RS densities, and according to the resources indicated in the configuration.

In method 500, at Block 504, the RS can be received over the first set of one or more RS occasions, and at Block 506, the RS can be received over the second set of RS occasions. In an aspect, RS measuring component 354, e.g., in conjunction with processor(s) 312, memory 316, transceiver 302, UE communicating component 342, etc., can receive the RS over the first set of one or more RS occasions and/or can receive the RS over the second set of one or more RS occasions such to receive the RS at the corresponding different RS densities, and according to the resources indicated in the configuration. RS measuring component 354 can measure a signal power or quality of the RSs as received based on the RS densities. For example, RS measuring component 354 can measure a RSSI, RSRP, RSRQ, SNR, SINR, etc. of the RSs received over the indicated resources for data collection for training a NN. In addition, RS measuring component 354 can differentiate between RSs received at the different RS densities based on the configuration.

In method 500, at Block 508, the first signal measurements identified as a first type of signal measurement and the second signal measurements identified as a second type of signal measurement can be provided for training a NN for CSI-RS transmission or channel estimation (or other purposes). In an aspect, NN training component 356, e.g., in conjunction with processor(s) 312, memory 316, transceiver 302, UE communicating component 342, etc., can provide the first signal measurements identified as a first type of signal measurement and the second signal measurements identified as a second type of signal measurement for training a NN for CSI-RS transmission or channel estimation. For example, NN training component 356 can provide the signal measurements along with signal measurement types (e.g., labeled or unlabeled, high or low density, etc.) to a component of the UE 104 that trains a local NN, or to a training entity (e.g., training entity 360) or other remotely located device that can perform the training and update the model at the UE 104 and/or network node. As described, identifying the type of signal measurement can improve model accuracy for transmitting CSI-RS or performing channel estimation using CSI-RSs.

For example, NN training component 356 can report the signal measurements including {H_raw, y_csirs} for labeled data (full density CSI-RS), and report {y_csirs} only for unlabeled data (low density CSI-RS), where H_raw can be the channel estimation, in terms of RB index, port-index and receiver index, Y_csirs can be in terms of RB index and receiver index. Where NN training component 356 reports metadata information, it may include one or more of a metadata identifier provided in the CSI-RS resource, a CC or cell ID, a CSI-RS resource ID (implicitly conveying the antenna mapping/layout), Low-density CSI-RS pattern or NN-based cover-code ID for unlabeled data (low density CSI-RS), UE location (e.g., global navigation satellite system (GNSS) location if available), etc. In addition, for example, the metadata information may include a list of records {record #1, record #2, etc.}, where each record can include a time stamp for the measurement, a signal measurement (e.g., SNR, SINR, RSRP, etc.), subcarrier spacing, Doppler/delay-spread measurement, etc. For example, the timestamp may include a CSI-RS transmission instances or slot index, or measurement duration index (e.g., a value based on a measurement of a certain duration, where the duration can be configured). For example, the network node may dynamically change the antenna mapping/layout, so timestamp can be useful to label the reported data with the associated antenna mapping/layout at the network node.

In one example, the configuration can indicate the RS resources and/or corresponding RS occasions for subsequent activation and/or deactivation of data collection using the RSs. For example, in method 600, optionally at Block 610, a command to activate data collection based on at least a set of the RS resources can be transmitted. In an aspect, configuring component 452, e.g., in conjunction with processor(s) 412, memory 416, transceiver 402, BS communicating component 442, etc., can transmit the command to activate data collection based on at least the set of the RS resources. For example, configuring component 452 can transmit the activation command as a MAC-CE or DCI, which may include an identifier (e.g., a collection configuration identifier that can relate to a RS resource or corresponding RS occasions indicated by the configuration, as described above). In one example, where the configuration in Block 602 is transmitted in RRC signaling and indicates periodic resources, a separate activation command may not be needed. If the RS is semi-persistent, however, the separate activation command can be used to activate data collection based on the RSs transmitted using different RS densities, as described. In an example, the configuration described above may include a dedicated resource configuration for data collection, and activating the resources (e.g., via activation command or otherwise) can activate the data collection. In another example, the configuration described above may include a generic resource configuration that can be used for other purposes (e.g., CSI feedback), and activating the resources and activating the data collection using the resources can be per different commands.

In method 500, optionally at Block 510, a command to activate data collection based on at least a set of the RS resources can be received. In an aspect, configuration applying component 352, e.g., in conjunction with processor(s) 312, memory 316, transceiver 302, UE communicating component 342, etc., can receive the command to activate data collection based on at least the set of the RS resources. As described, for example, configuration applying component 352 can receive the command in a MAC-CE or DCI to activate data collection for RS resources indicated in the configuration received at Block 502 (e.g., in RRC signaling). Configuration applying component 352 can apply the configuration for data collection based on the activation command, which may be for a period of time indicated in the activation command or until a deactivation command is received, as described herein. While the data collection is activated, as described above, RS measuring component 354 can measure RSs at various RS densities as indicated in the configuration for providing for NN training.

In one example, where the configuration transmitted at Block 602, or received at Block 502, is a dedicated resource configuration for RSs for data collection, and if the RS is semi-persistent, the activation command transmitted or received in MAC-CE can include a list of activated collection configuration identifiers, as described above, where the collection configuration identifiers can correspond to a RS resource with multiple configured densities, a combination (or pair) of RS resources, a given RS resource having a corresponding density, etc. RS measuring component 354 can begin measuring RSs received according to the parameters specified for the collection configuration identifiers. Where the activation command is transmitted or received in DCI, in this example, the command can similarly include an activated collection configuration identifier or a trigger state identifier. For example, the network node can configure the UE with trigger state identifiers and associated collection configuration identifiers, such that based on the indication of the trigger state identifier in the DCI, configuration applying component 352 can determine the associated list of collection configuration identifiers for activation. In another example, configuring component 452 can select a radio network temporary identifier (RNTI) used to scramble the DCI to indicate whether the DCI is for activation or deactivation of data collection, and configuration applying component 352 can determine whether the DCI is for activation or deactivation based on the RNTI used to scramble the DCI.

In another example, where the configuration transmitted at Block 602, or received at Block 502, is a generic resource configuration for other purposes, but usable for measuring RSs for data collection, and if the RS is semi-persistent, the activation command transmitted or received in MAC-CE can include a list of resource or resource set identifiers indicating resources over which RSs received can be used for data collection. RS measuring component 354 can begin measuring RSs received in the list of resources or resource set identifiers for measuring for training a NN. The command transmitted or received in MAC-CE may also include metadata information (or corresponding identifier) for each of the resources or resource sets, and RS measuring component 354 can use this metadata information for associating with the measurements, as described. The command transmitted or received in MAC-CE may also include a bit indicating whether the command is for activating or deactivating data collection on the RS resources. Where the activation command is transmitted or received in DCI, in this example, the command can include a trigger state identifier. In this example, the network node can configure the UE with trigger state identifiers and associated resources or resource sets identifiers, such that based on the indication of the trigger state identifier in the DCI, configuration applying component 352 can determine the resources or resource sets over which to receive and measure RSs for data collection. In addition, in this example, where the activation command is transmitted or received in DCI, the activation command can include the metadata information or associated identifier, as described above, or may include the bit indicating whether the command is for activation or deactivation of data collection over the resources. In another example, configuring component 452 can select a RNTI used to scramble the DCI to indicate whether the DCI is for activation or deactivation of data collection, and configuration applying component 352 can determine whether the DCI is for activation or deactivation based on the RNTI used to scramble the DCI.

In one example, activation command can be transmitted or received in a group-common DCI that uses multiple segmentation, where each segment can include a data collection command (and/or associated metadata information or identifier). For example, each UE can be configured via RRC with a starting bit or field to read in the group-common DCI, and a length of bit or field to read in the group-common DCI. In this example, configuration applying component 352 can receive the group-common DCI and can determine a segment of the group-common DCI that corresponds to the UE 104 based on the RRC configuration indicating the starting bit or field and the length. Configuration applying component 352 can then obtain the data collection command and/or metadata from the group DCI for determining the RS resources over which to measure RSs for data collection and/or the associated metadata, as described above.

In one example, where the configuration indicates separate RS resources that are not combined or paired, the activation command can separately activate RS resources of different RS densities. For example, configuring component 452 can generate the activation command to indicate activation of multiple different RS resources, or can generate multiple activation commands each activating a RS resource, etc. In one example, configuring component 452 can generate the activation command as a MAC-CE or DCI that triggers two lists of CSI-RS resources for data collection, one with full density and one with low density, as described herein, which may implicitly indicate a one-to-one mapping between the RS resources. Configuration applying component 352 can receive the activation command (or multiple activation commands) in MAC-CE or DCI signaling, and can accordingly apply the configuration such that RS measuring component 354 can receive and measure RSs received over the corresponding resources activated for data collection.

In one example, the network node can transmit the activation command based on receiving a request for data collection (e.g., from the UE 104). In method 500, optionally at Block 512, a request for data collection can be transmitted. In an aspect, configuration applying component 352, e.g., in conjunction with processor(s) 312, memory 316, transceiver 302, UE communicating component 342, etc., can transmit the request for data collection. For example, configuration applying component 352 can transmit the request in a dedicated scheduling request (SR) for data collection, which may be configured by the network node or otherwise indicate in a wireless communication technology standard, such as 5G NR. For example, the request can indicate one or more collection configuration identifiers for which activation is requested, a trigger state identifier that corresponds to a list of resource or resource set identifiers for which activation is requested, as described above, a bit requesting or not requesting data collection, etc. In an example, configuration applying component 352 can transmit the request in a MAC-CE, in physical uplink shared channel (PUSCH) communications, etc.

In method 600, optionally at Block 612, a request for data collection can be received. In an aspect, configuring component 452, e.g., in conjunction with processor(s) 412, memory 416, transceiver 402, BS communicating component 442, etc., can receive the request for data collection (e.g., from the UE 104). In an example, configuring component 452 can configure or activate the RS resources for data collection based on the request (e.g., based on activating the indicated collection configuration identifiers). Configuring component 452 can accordingly transmit the activation command based on the request, in one example. In this example, RS component 454 can transmit the RSs based on the configuration, activate data collection over the RSs based on transmitting the activation command, etc., based on the request from the UE. In one example, where the activation command is sent, the UE 104 can perform data collection for a time period specified in the activation command or until a deactivation command is transmitted by the network node.

In method 600, optionally at Block 614, a command to deactivate data collection on a set of the RS resources can be transmitted. In an aspect, configuring component 452, e.g., in conjunction with processor(s) 412, memory 416, transceiver 402, BS communicating component 442, etc., can transmit the command to deactivate data collection on the set of RS resources. For example, this deactivation command can have a similar format as the activation command, and can identify RSs for which data collection is to be deactivated (e.g., by indicating a collection configuration identifier, a resource or resource set identifier, a trigger state identifier, etc.). In addition, configuring component 452 can similarly transmit the deactivation command in MAC-CE, DCI, etc.

In method 500, optionally at Block 514, a command to deactivate data collection on a set of the RS resources can be received. In an aspect, configuration applying component 352, e.g., in conjunction with processor(s) 312, memory 316, transceiver 302, UE communicating component 342, etc., can receive the command to deactivate data collection on the set of RS resources. For example, configuration applying component 352 can determine which RS resources over which to deactivate data collection based on information in the deactivation command, such as a collection configuration identifier, a resource or resource set identifier, a trigger state identifier, etc., and can refrain from processing the RSs or at least refrain from including RS measurements in data collection for training the NN based on receiving the deactivation command. In one example, NN training component 356 can provide the signal measurements for training the NN based on receiving the deactivation command. In other examples, NN training component 356 can provide the signal measurements periodically while performing the measurements, after each measurement is performed, etc.

In method 500, optionally at Block 516, a first capability indicating support for data collection based on the first RS density and a second capability indicating support for data collection based on the second RS density can be transmitted. In an aspect, configuration applying component 352, e.g., in conjunction with processor(s) 312, memory 316, transceiver 302, UE communicating component 342, etc., can transmit the first capability indicating support for data collection based on the first RS density and the second capability indicating support for data collection based on the second RS density. For example, configuration applying component 352 can transmit the capabilities to the network node to indicate support for receiving RSs at different RS densities for data collection. For example, the support can relate to periodicities supported for receiving the RSs for performing data collection.

In method 600, optionally at Block 616, a first capability indicating support for data collection based on the first RS density and a second capability indicating support for data collection based on the second RS density can be received. In an aspect, configuring component 452, e.g., in conjunction with processor(s) 412, memory 416, transceiver 402, BS communicating component 442, etc., can receive the first capability indicating support for data collection based on the first RS density and the second capability indicating support for data collection based on the second RS density.

For example, UEs can use RSs for data collection, as described, but RSs may have long RS periodicity, which can lead to inefficient data collection. Short periodicity, however, can lead to more data for processing, and the UE may not be able to frequently handle all the data collection, resulting in waste of RS overhead. As such, for example, configuration applying component 352 can report multiple (e.g., two) capabilities of supported data collection RS periodicity, a first capability for labeled data collection (higher density), and a second capability for unlabeled data collection (lower density). Configuring component 452 may configure the RS periodicity considering the capability—e.g., configured RS periodicity can be greater than or equal to the indicated capability. In this example, configuration applying component 352 can determine when/which RS occasion to perform data collection, and NN training component 356 can determine when to upload the measured data for training the NN.

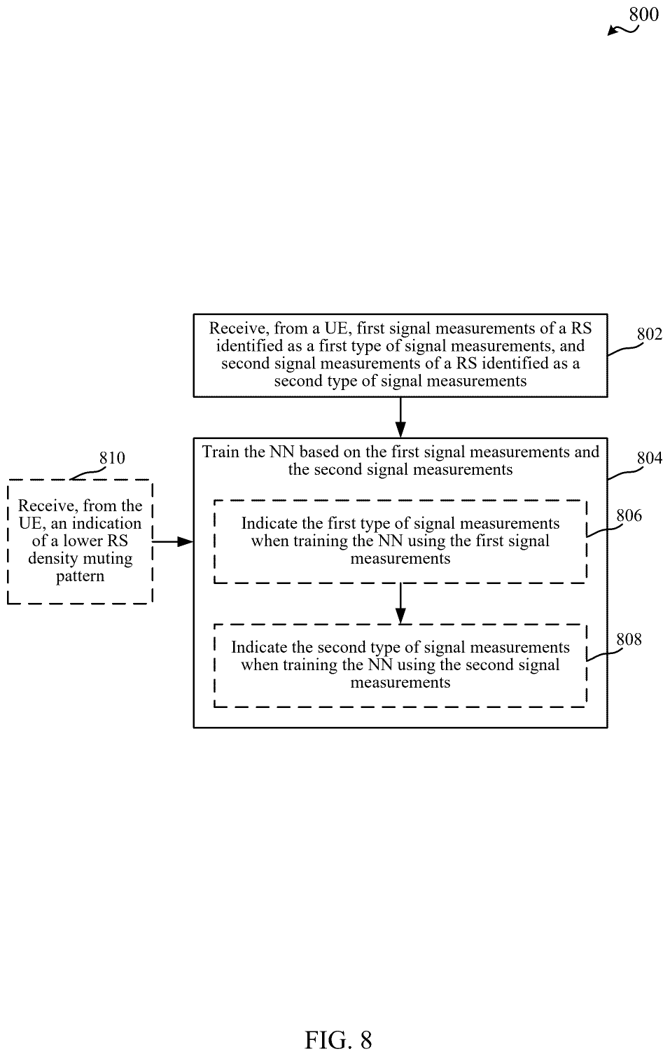

FIG. 8 illustrates a flow chart of an example of a method 800 for training a NN based on RSs transmitted according to different RS densities, in accordance with aspects described herein. In an example, a training entity 360 can perform the functions described in method 800 using one or more of the components described in FIG. 3.

In method 800, at Block 802, first signal measurements of a RS identified as a first type of signal measurements and second signal measurements of the RS identified as a second type of signal measurements can be received from a UE. In an aspect, NN training component 366, e.g., in conjunction with processor(s) 364, memory 362, etc., can receive, from the UE (e.g., UE 104), the first signal measurements of the RS identified as the first type of signal measurements and second signal measurements of the RS identified as the second type of signal measurements. For example, the first signal measurements can be identified as a type associated with a first RS density (e.g., a high RS density, such as labeled data), and the second signal measurements can be identified as a type associated with a second RS density (e.g., a low RS density, such as unlabeled data). In addition, for example, other data can be indicated for the signal measurements, such as certain metadata information provided to the UE 104 in a configuration for the associated RSs, as described above.

In method 800, at Block 804, a NN can be trained based on the first signal measurements and the second signal measurements. In an aspect, NN training component 366, e.g., in conjunction with processor(s) 364, memory 362, etc., can train the NN based on the first signal measurements and the second signal measurements. For example, the NN can be stored in memory 362 of the training entity 360 and can be trained using one or more AI or ML learning processes. The training entity 360, in an example, can provide trained NN models to the UE 104 and/or network nodes that serve the UE 104 following training, so that the NN models can be used for different processes, such as CSI-RS transmission, channel estimation, etc.

In an example, training the NN at Block 804 can optionally include, at Block 806, indicating the first type of signal measurements when training the NN using the first signal measurements, and/or at Block 808, indicating the second type of signal measurements when training the NN using the second signal measurements. In an aspect, NN training component 366, e.g., in conjunction with processor(s) 364, memory 362, etc., can indicate the first type of signal measurements when training the NN using the first signal measurements, and/or indicate the second type of signal measurements when training the NN using the second signal measurements. Thus, the NN can be trained along with the measurement type (e.g., high density or labeled data, low density or unlabeled data, etc.) and/or metadata information that may be provided with the corresponding RSs. In an example, the second signal measurements may include an indication of a low density RS pattern or NN-based cover-code used to determine the resources over which to receive the RSs for the second signal measurements. In this example, NN training component 366 can also indicate this information in training the NN.

In one example, where the first signal measurements are based on a full CSI-RS density, NN training component 366 can select a subset of the first signal measurements for training the NN. For example, NN training component 366 can select the subset based on applying a lower RS density muting pattern to the first signal measurements. For example, the lower RS density muting pattern may be similar to the muting patterns described above. In one example, NN training component 366 can use a same muting pattern as applied by the UE 104 in performing the second signal measurements (e.g., such to consider the first signal measurements that were taken over the same REs as the second signal measurements). In another example, NN training component 366 can select the muting pattern.

In yet another example, NN training component 366 can use a muting pattern indicated by the UE. In method 800, optionally at Block 810, an indication of a lower RS density muting pattern can be received from the UE. In an aspect, NN training component 366, e.g., in conjunction with processor(s) 364, memory 362, etc., can receive, from the UE, the indication of the lower RS density muting pattern. For example, the UE 104 can indicate the lower RS density muting pattern to be used for the first signal measurements, and NN training component 366 can use this muting pattern in determining which of the first signal measurements to indicate in training the NN.

FIG. 9 is a block diagram of a MIMO communication system 900 including a base station 102 and a UE 104. The MIMO communication system 900 may illustrate aspects of the wireless communication access network 100 described with reference to FIG. 1. The base station 102 may be an example of aspects of the base station 102 described with reference to FIG. 1. The base station 102 may be equipped with antennas 934 and 935, and the UE 104 may be equipped with antennas 952 and 953. In the MIMO communication system 900, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 920 may receive data from a data source. The transmit processor 920 may process the data. The transmit processor 920 may also generate control symbols or reference symbols. A transmit MIMO processor 930 may perform spatial processing (e.g., precoding) on data symbols, control symbols, or reference symbols, if applicable, and may provide output symbol streams to the transmit modulator/demodulators 932 and 933. Each modulator/demodulator 932 through 933 may process a respective output symbol stream (e.g., for OFDM, etc.) to obtain an output sample stream. Each modulator/demodulator 932 through 933 may further process (e.g., convert to analog, amplify, filter, and upconvert) the output sample stream to obtain a DL signal. In one example, DL signals from modulator/demodulators 932 and 933 may be transmitted via the antennas 934 and 935, respectively.

The UE 104 may be an example of aspects of the UEs 104 described with reference to FIGS. 1 and 3. At the UE 104, the UE antennas 952 and 953 may receive the DL signals from the base station 102 and may provide the received signals to the modulator/demodulators 954 and 955, respectively. Each modulator/demodulator 954 through 955 may condition (e.g., filter, amplify, downconvert, and digitize) a respective received signal to obtain input samples. Each modulator/demodulator 954 through 955 may further process the input samples (e.g., for OFDM, etc.) to obtain received symbols. A MIMO detector 956 may obtain received symbols from the modulator/demodulators 954 and 955, perform MIMO detection on the received symbols, if applicable, and provide detected symbols. A receive (Rx) processor 958 may process (e.g., demodulate, deinterleave, and decode) the detected symbols, providing decoded data for the UE 104 to a data output, and provide decoded control information to a processor 980, or memory 982.

The processor 980 may in some cases execute stored instructions to instantiate a UE communicating component 342 (see e.g., FIGS. 1 and 3).

On the uplink (UL), at the UE 104, a transmit processor 964 may receive and process data from a data source. The transmit processor 964 may also generate reference symbols for a reference signal. The symbols from the transmit processor 964 may be precoded by a transmit MIMO processor 966 if applicable, further processed by the modulator/demodulators 954 and 955 (e.g., for single carrier-FDMA, etc.), and be transmitted to the base station 102 in accordance with the communication parameters received from the base station 102. At the base station 102, the UL signals from the UE 104 may be received by the antennas 934 and 935, processed by the modulator/demodulators 932 and 933, detected by a MIMO detector 936 if applicable, and further processed by a receive processor 938. The receive processor 938 may provide decoded data to a data output and to the processor 940 or memory 942.

The processor 940 may in some cases execute stored instructions to instantiate a BS communicating component 442 (see e.g., FIGS. 1 and 4).

The components of the UE 104 may, individually or collectively, be implemented with one or more ASICs adapted to perform some or all of the applicable functions in hardware. Each of the noted modules may be a means for performing one or more functions related to operation of the MIMO communication system 900. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 900.

The following aspects are illustrative only and aspects thereof may be combined with aspects of other embodiments or teaching described herein, without limitation.

Aspect 1 is a method for wireless communication at a UE including receiving a configuration indicating RS resources including at least a first set of one or more RS occasions of a first RS density and a second set of one or more RS occasions of a second RS density, performing first signal measurements of RSs received over the first set of one or more RS occasions, performing second signal measurements of RSs received over the second set of RS occasions, and providing the first signal measurements identified as a first type of signal measurements and the second signal measurements identified as a second type of signal measurements for training a neural network for CSI-RS transmission or channel estimation.

In Aspect 2, the method of Aspect 1 includes where the configuration includes, for a given one of the RS resources, an indication of the first RS density and the second RS density, where the first RS density corresponds to a higher density than the second RS density.

In Aspect 3, the method of Aspect 2 includes where the first RS density and the second RS density correspond to one of a spatial RS density, a frequency RS density, or a time RS density.

In Aspect 4, the method of any of Aspects 2 or 3 includes where the configuration indicates, for the RS resources, at least one of a component carrier or cell identifier, or a list of the first set of one or more RS occasions and the second set of one or more RS occasions.

In Aspect 5, the method of Aspect 4 includes where the configuration includes, for the given one of the RS resources, a first periodicity and a first offset configuration for the first set of one or more RS occasions and a second periodicity and a second offset configuration for the second set of one or more RS occasions.

In Aspect 6, the method of any of Aspects 4 or 5 includes where the configuration includes, for the given one of the RS resources, a resource pattern mapping configuration mapping resource elements in a resource pattern to one or more antenna ports.

In Aspect 7, the method of Aspect 6 includes where the resource pattern mapping configuration includes a first resource pattern mapping configuration for the first set of one or more RS occasions and a second resource pattern mapping configuration for the second set of one or more RS occasions.

In Aspect 8, the method of any of Aspects 6 or 7 includes where the resource pattern mapping configuration includes a first resource pattern mapping configuration for the first set of one or more RS occasions and a muting configuration for the second set of one or more RS occasions indicating resources in the resource over which the RS is not transmitted.

In Aspect 9, the method of Aspect 8 includes where the configuration includes a lower RS density muting configuration for the first set of one or more RS occasions for providing to a training entity for training the NN.

In Aspect 10, the method of any of Aspects 8 or 9 includes where the muting configuration is indicated for all of the one or more antenna ports, or a portion of the one or more antenna ports.

In Aspect 11, the method of any of Aspects 2 to 10 includes where the configuration indicates, for each resource, at least one of quasi-colocation information or bandwidth part information.

In Aspect 12, the method of any of Aspects 2 to 11 includes where the configuration indicates, for each resource, metadata including at least one of an antenna layout, an antenna element to transceiver unit mapping, a digital/analog precoding, or an identifier to indicate at least one of an antenna layout, an antenna element to transceiver unit mapping, a digital/analog precoding.

In Aspect 13, the method of any of Aspects 1 to 12 includes where the configuration includes an indication of at least a resource combination of a first RS resource corresponding to the first set of one or more RS occasions and a second RS resource corresponding to the second set of one or more RS occasions, where the first RS density corresponds to a higher density than the second RS density.

In Aspect 14, the method of Aspect 13 includes where the first RS density and the second RS density correspond to one of a spatial RS density, a frequency RS density, or a time RS density.

In Aspect 15, the method of any of Aspects 13 or 14 includes where the configuration indicates, for the resource combination, at least one of a component carrier or cell identifier, quasi-colocation information, bandwidth part information, metadata identifier, or resource pattern mapping configuration mapping resource elements in a resource pattern to one or more antenna ports.

In Aspect 16, the method of Aspect 15 includes where the configuration indicates a cover-code identifier for the second RS resource.

In Aspect 17, the method of any of Aspects 1 to 16 includes where the configuration includes an indication of a first RS resource corresponding to the first set of one or more RS occasions, and a second RS resource corresponding to the second set of one or more RS occasions.

In Aspect 18, the method of Aspect 17 includes receiving a command to one of activate or deactivate data collection based on the first RS resource or the second RS resource.

In Aspect 19, the method of any of Aspects 17 or 18 includes receiving a command to one of activate or deactivate data collection based on the first RS resource and the second RS resource.

In Aspect 20, the method of any of Aspects 1 to 19 includes receiving a command to one of activate or deactivate data collection based on at least a set of the RS resources.

In Aspect 21, the method of Aspect 20 includes where the configuration indicates a collection configuration identifier for each of the set of the RS resources, where the command includes a list of the collection configuration identifiers for which data collection is to be activated or deactivated.

In Aspect 22, the method of any of Aspects 20 or 21 includes where the configuration indicates a portion of the set of the RS resources for which data collection is to be activated or deactivated.

In Aspect 23, the method of any of Aspects 20 to 22 includes where the command is received in a MAC-CE, and where the command includes, for at least a portion of the set of RS resources that are semi-persistent, a list of collection configuration identifiers for which data collection is to be activated.

In Aspect 24, the method of any of Aspects 20 to 23 includes where the command is received in a MAC-CE including a list of at least a portion of the set of RS resources, and metadata identifier for the portion of the set of RS resources.

In Aspect 25, the method of Aspect 24 includes where the command includes a bit indicating whether the command is for activating or deactivating data collection.

In Aspect 26, the method of any of Aspects 20 to 25 includes where the command is received in a DCI, and where the command includes, for at least a portion of the set of RS resources that are semi-persistent, at least one of a list of collection configuration identifiers for which data collection is to be activated or a trigger state identifier corresponding to a set of collection configuration identifiers for which data collection is to be activated.

In Aspect 27, the method of any of Aspects 20 to 26 includes where the command is received in a DCI including a trigger state identifier corresponding to a set of collection configuration identifiers for which data collection is to be activated for at least a portion of the set of RS resources, and metadata identifier for the portion of the set of RS resources.

In Aspect 28, the method of any of Aspects 20 to 27 includes where the command is a group-common DCI including multiple segmentation each having a data collection request corresponding to one of the set of the RS resources.

In Aspect 29, the method of any of Aspects 20 to 28 includes where the command includes one of a RNTI or a toggle bit to indicate whether the command is to activate or deactivate data collection.

In Aspect 30, the method of any of Aspects 20 to 29 includes transmitting a request for data collection, where receiving the command includes receiving the command to activate data collection based on the request.

In Aspect 31, the method of Aspect 30 includes where transmitting the request includes transmitting a scheduling request dedicated for data collection activation including one of a collection configuration identifier for which data collection is requested to be activated, a trigger state identifier indicating at least a portion of the set of the RS resources for which data collection is requested to be activated, or a bit indicating requesting or not requesting data collection.

In Aspect 32, the method of any of Aspects 30 or 31 includes where the request defines a MAC-CE over which to transmit the command.

In Aspect 33, the method of any of Aspects 1 to 32 includes transmitting a first capability indicating support for data collection based on the first RS density and a second capability indicating support for data collection based on the second RS density.

In Aspect 34, the method of any of Aspects 1 to 33 includes where providing the first signal measurements and the second signal measurements for training a neural network includes transmitting, to a training entity that trains the neural network, the first signal measurements identified as the first type of signal measurements and the second signal measurements identified as the second type of signal measurements.

Aspect 35 is a method for wireless communication at a network node including transmitting a configuration indicating RS resources including at least a first set of one or more RS occasions of a first RS density and a second set of one or more RS occasions of a second RS density, transmitting the RS over the first set of one or more RS occasions, and transmitting the RS over the second set of one or more RS occasions.

In Aspect 36, the method of Aspect 35 includes where the configuration includes, for a given one of the RS resources, an indication of the first RS density and the second RS density, where the first RS density corresponds to a higher density than the second RS density.

In Aspect 37, the method of Aspect 36 includes where the first RS density and the second RS density correspond to one of a spatial RS density, a frequency RS density, or a time RS density.

In Aspect 38, the method of any of Aspects 36 or 37 includes where the configuration indicates, for the RS resources, at least one of a component carrier or cell identifier, or a list of the first set of one or more RS occasions and the second set of RS one or more occasions.

In Aspect 39, the method of Aspect 38 includes where the configuration includes, for the given one of the RS resources, a first periodicity and a first offset configuration for the first set of one or more RS occasions and a second periodicity and a second offset configuration for the second RS set of one or more RS occasions.

In Aspect 40, the method of any of Aspects 38 or 39 includes where the configuration includes, for the given one of the RS resources, a resource pattern mapping configuration mapping resource elements in a resource pattern to one or more antenna ports.

In Aspect 41, the method of Aspect 40 includes where the resource pattern mapping configuration includes a first resource pattern mapping configuration for the first set of one or more RS occasions and a second resource pattern mapping configuration for the second set of one or more RS occasions.

In Aspect 42, the method of any of Aspects 40 or 41 includes where the resource pattern mapping configuration includes a first resource pattern mapping configuration for the first set of one or more RS occasions and a muting configuration for the second set of one or more RS occasions indicating resources in the resource over which the RS is not transmitted.

In Aspect 43, the method of Aspect 42 includes where the configuration includes a lower RS density muting configuration for the first set of one or more RS occasions for providing to a training entity for training a neural network.

In Aspect 44, the method of any of Aspects 42 or 43 includes where the muting configuration is indicated for all of the one or more antenna ports, or a portion of the one or more antenna ports.

In Aspect 45, the method of any of Aspects 36 to 44 includes where the configuration indicates, for each resource, at least one of quasi-colocation information or bandwidth part information.

In Aspect 46, the method of any of Aspects 36 to 45 includes where the configuration indicates, for each resource, metadata including at least one of an antenna layout, an antenna element to transceiver unit mapping, a digital/analog precoding, or an identifier to indicate at least one of an antenna layout, an antenna element to transceiver unit mapping, a digital/analog precoding.

In Aspect 47, the method of any of Aspects 35 to 46 includes where the configuration includes an indication of at least a resource combination of a first RS resource corresponding to the first set of one or more RS occasions and a second RS resource corresponding to the second set of one or more RS occasions, where the first RS density corresponds to a higher density than the second RS density.

In Aspect 48, the method of Aspect 47 includes where the first RS density and the second RS density correspond to one of a spatial RS density, a frequency RS density, or a time RS density.

In Aspect 49, the method of any of Aspects 47 or 48 includes where the configuration indicates, for the resource combination, at least one of a component carrier or cell identifier, quasi-colocation information, bandwidth part information, metadata identifier, or resource pattern mapping configuration mapping resource elements in a resource pattern to one or more antenna ports.

In Aspect 50, the method of any of Aspects 47 to 49 includes where the configuration indicates a cover-code identifier for the second RS resource.

In Aspect 51, the method of any of Aspects 35 to 50 includes where the configuration includes an indication of a first RS resource corresponding to the first set of one or more RS occasions, and a second RS resource corresponding to the second set of one or more RS occasions.

In Aspect 52, the method of Aspect 51 includes transmitting a command to one of activate or deactivate data collection based on the first RS resource or the second RS resource.

In Aspect 53, the method of any of Aspects 51 or 52 includes transmitting a command to one of activate or deactivate data collection based on the first RS resource and the second RS resource.

In Aspect 54, the method of any of Aspects 35 to 53 includes transmitting a command to one of activate or deactivate data collection based on at least a set of the RS resources.

In Aspect 55, the method of Aspect 54 includes where the configuration indicates a collection configuration identifier for each of the set of the RS resources, where the command includes a list of the collection configuration identifiers for which data collection is to be activated or deactivated.

In Aspect 56, the method of any of Aspects 54 or 55 includes where the configuration indicates a portion of the set of the RS resources for which data collection is to be activated or deactivated.

In Aspect 57, the method of any of Aspects 54 to 56 includes where the command is transmitted in a MAC-CE, and where the command includes, for at least a portion of the set of RS resources that are semi-persistent, a list of collection configuration identifiers for which data collection is to be activated.

In Aspect 58, the method of any of Aspects 54 to 57 includes where the command is transmitted in a MAC-CE including a list of at least a portion of the set of RS resources, and metadata identifier for the portion of the set of RS resources.

In Aspect 59, the method of Aspect 58 includes where the command includes a bit indicating whether the command is for activating or deactivating data collection.

In Aspect 60, the method of any of Aspects 54 to 59 includes where the command is transmitted in a DCI, and where the command includes, for at least a portion of the set of RS resources that are semi-persistent, at least one of a list of collection configuration identifiers for which data collection is to be activated or a trigger state identifier corresponding to a set of collection configuration identifiers for which data collection is to be activated.

In Aspect 61, the method of any of Aspects 54 to 60 includes where the command is transmitted in a DCI including a trigger state identifier corresponding to a set of collection configuration identifiers for which data collection is to be activated for at least a portion of the set of RS resources, and metadata identifier for the portion of the set of RS resources.

In Aspect 62, the method of any of Aspects 54 to 61 includes where the command is a group-common DCI including multiple segmentation each having a data collection request corresponding to one of the set of RS resources.

In Aspect 63, the method of any of Aspects 54 to 62 includes where the command includes one of a RNTI or a toggle bit to indicate whether the command is to activate or deactivate data collection.

In Aspect 64, the method of any of Aspects 54 to 63 includes receiving a request for data collection, where transmitting the command includes transmitting the command to activate data collection based on the request.

In Aspect 65, the method of Aspect 64 includes where receiving the request includes receiving a scheduling request dedicated for data collection activation including one of a collection configuration identifier for which data collection is requested to be activated, a trigger state identifier indicating at least a portion of the set of RS resources for which data collection is requested to be activated, or a bit indicating requesting or not requesting data collection.

In Aspect 66, the method of any of Aspects 64 or 65 includes where the request defines a MAC-CE over which to transmit the command.

In Aspect 67, the method of any of Aspects 35 to 66 includes receiving a first capability indicating support for data collection based on the first RS density and a second capability indicating support for data collection based on the second RS density, where transmitting the configuration is based on the first capability and the second capability.

Aspect 68 is a method for training a NN for CSI-RS transmission or channel estimation including receiving, from a UE, first signal measurements of a RS identified as a first type of signal measurements, and second signal measurements of the RS identified as a second type of signal measurements, where the first type of signal measurements is associated with a first RS density of the RS, and the second type of signal measurements is associated with a second RS density of the RS, and training the NN based on the first signal measurements and the second signal measurements, where training the NN includes indicating the first type of signal measurements when training the NN using the first signal measurements, and indicating the second type of signal measurements when training the NN using the second signal measurements.

In Aspect 69, the method of Aspect 68 includes where the first RS density corresponds to a higher density than the second RS density, and where training the NN includes training the NN based on selecting a subset of the first signal measurements corresponding to a lower RS density muting pattern.

In Aspect 70, the method of Aspect 69 includes where the lower RS density muting pattern is the same as a second RS density muting pattern associated with the second RS density.

In Aspect 71, the method of any of Aspects 69 or 70 includes receiving, from the UE, an indication of the lower RS density muting pattern.

In Aspect 72, the method of any of Aspects 69 to 71 includes where training the NN includes indicating a lower density RS pattern or NN-based cover-code associated with the second type of signal measurements when training the NN using the second signal measurements.

Aspect 73 is an apparatus for wireless communication including a processor, memory coupled with the processor, and instructions stored in the memory and operable, when executed by the processor, to cause the apparatus to perform any of the methods of Aspects 1 to 72.

Aspect 74 is an apparatus for wireless communication including means for performing any of the methods of Aspects 1 to 72.

Aspect 75 is a computer-readable medium including code executable by one or more processors for wireless communications, the code including code for performing any of the methods of Aspects 1 to 72.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a processor;
memory coupled with the processor; and
instructions stored in the memory and operable, when executed by the processor, to cause the apparatus to:
receive a configuration indicating reference signal (RS) resources including at least a first set of one or more RS occasions of a first RS density and a second set of one or more RS occasions of a second RS density;
perform first signal measurements of RSs received over the first set of one or more RS occasions;
perform second signal measurements of RSs received over the second set of RS occasions; and
provide the first signal measurements identified as a first type of signal measurements and the second signal measurements identified as a second type of signal measurements for training a neural network (NN) for channel state information reference signal (CSI-RS) transmission or channel estimation.

2. The apparatus of claim 1, wherein the configuration includes, for a given one of the RS resources, an indication of the first RS density and the second RS density, wherein the first RS density corresponds to a higher density than the second RS density.

3. The apparatus of claim 2, wherein the first RS density and the second RS density correspond to one of a spatial RS density, a frequency RS density, or a time RS density.

4. The apparatus of claim 2, wherein the configuration indicates, for the RS resources, at least one of a component carrier or cell identifier, or a list of the first set of one or more RS occasions and the second set of one or more RS occasions.

5. The apparatus of claim 4, wherein the configuration includes, for the given one of the RS resources, a first periodicity and a first offset configuration for the first set of one or more RS occasions and a second periodicity and a second offset configuration for the second set of one or more RS occasions.

6. The apparatus of claim 4, wherein the configuration includes, for the given one of the RS resources, a resource pattern mapping configuration mapping resource elements in a resource pattern to one or more antenna ports.

7. The apparatus of claim 6, wherein the resource pattern mapping configuration includes a first resource pattern mapping configuration for the first set of one or more RS occasions and a second resource pattern mapping configuration for the second set of one or more RS occasions.

8. The apparatus of claim 6, wherein the resource pattern mapping configuration includes a first resource pattern mapping configuration for the first set of one or more RS occasions and a muting configuration for the second set of one or more RS occasions indicating resources in the resource over which the RS is not transmitted.

9. The apparatus of claim 8, wherein the configuration includes a lower RS density muting configuration for the first set of one or more RS occasions for providing to a training entity for training the NN.

10. The apparatus of claim 8, wherein the muting configuration is indicated for all of the one or more antenna ports, or a portion of the one or more antenna ports.

11. The apparatus of claim 2, wherein the configuration indicates, for each resource, at least one of quasi-colocation information, bandwidth part information, an antenna layout, an antenna element to transceiver unit mapping, a digital/analog precoding, or an identifier to indicate at least one of an antenna layout, an antenna element to transceiver unit mapping, a digital/analog precoding.

12. The apparatus of claim 1, wherein the configuration includes an indication of at least a resource combination of a first RS resource corresponding to the first set of one or more RS occasions and a second RS resource corresponding to the second set of one or more RS occasions, wherein the first RS density corresponds to a higher density than the second RS density.

13. The apparatus of claim 12, wherein the first RS density and the second RS density correspond to one of a spatial RS density, a frequency RS density, or a time RS density.

14. The apparatus of claim 12, wherein the configuration indicates, for the resource combination, at least one of a component carrier or cell identifier, quasi-colocation information, bandwidth part information, metadata identifier, resource pattern mapping configuration mapping resource elements in a resource pattern to one or more antenna ports, or a cover-code identifier for the second RS resource.

15. The apparatus of claim 1, wherein the instructions, when executed by the processor, to cause the apparatus to receive a command to one of activate or deactivate data collection based on at least a set of the RS resources.

16. The apparatus of claim 15, wherein the configuration indicates a collection configuration identifier for each of the set of the RS resources, where the command includes a list of the collection configuration identifiers for which data collection is to be activated or deactivated.

17. The apparatus of claim 15, wherein the configuration indicates a portion of the set of the RS resources for which data collection is to be activated or deactivated.

18. The apparatus of claim 15, wherein the command is received in a media access control (MAC)-control element (CE), and wherein the command includes at least one of:
for at least a portion of the set of RS resources that are semi-persistent, a list of collection configuration identifiers for which data collection is to be activated;
a list of at least a portion of the set of RS resources, and metadata identifier for the portion of the set of RS resources; or
a bit indicating whether the command is for activating or deactivating data collection.

19. The apparatus of claim 15, wherein the command is received in a downlink control information (DCI), and wherein the command includes at least one of:
for at least a portion of the set of RS resources that are semi-persistent, at least one of a list of collection configuration identifiers for which data collection is to be activated or a trigger state identifier corresponding to a set of collection configuration identifiers for which data collection is to be activated;
a trigger state identifier corresponding to a set of collection configuration identifiers for which data collection is to be activated for at least a portion of the set of RS resources, and metadata identifier for the portion of the set of RS resources;
a radio network temporary identifier (RNTI); or
a toggle bit to indicate whether the command is to activate or deactivate data collection.

20. The apparatus of claim 15, wherein the command is a group-common downlink control information (DCI) including multiple segmentation each having a data collection request corresponding to one of the set of the RS resources.

21. The apparatus of claim 20, wherein the instructions, when executed by the processor, to cause the apparatus to transmit a request for data collection, wherein the instructions, when executed by the processor, to cause the apparatus to receive the command to activate data collection based on the request.

22. The apparatus of claim 21, wherein the instructions, when executed by the processor, to cause the apparatus to transmit the request as a scheduling request dedicated for data collection activation including one of a collection configuration identifier for which data collection is requested to be activated, a trigger state identifier indicating at least a portion of the set of the RS resources for which data collection is requested to be activated, or a bit indicating requesting or not requesting data collection.

23. The apparatus of claim 1, wherein the instructions, when executed by the processor, to cause the apparatus to transmit a first capability indicating support for data collection based on the first RS density and a second capability indicating support for data collection based on the second RS density.

24. The apparatus of claim 1, wherein the instructions, when executed by the processor, to cause the apparatus to provide the first signal measurements and the second signal measurements for training a NN at least in part by transmitting, to a training entity that trains the NN, the first signal measurements identified as the first type of signal measurements and the second signal measurements identified as the second type of signal measurements.

25. An apparatus for wireless communication, comprising:
a processor;
memory coupled with the processor; and
instructions stored in the memory and operable, when executed by the processor, to cause the apparatus to:
transmit a configuration indicating reference signal (RS) resources including at least a first set of one or more RS occasions of a first RS density and a second set of one or more RS occasions of a second RS density;
transmit the RS over the first set of one or more RS occasions; and
transmit the RS over the second set of one or more RS occasions.

26. The apparatus of claim 25, wherein the configuration includes, for a given one of the RS resources, an indication of the first RS density and the second RS density, wherein the first RS density corresponds to a higher density than the second RS density.

27. A method for wireless communication at a user equipment (UE), comprising:
receiving a configuration indicating reference signal (RS) resources including at least a first set of one or more RS occasions of a first RS density and a second set of one or more RS occasions of a second RS density;
performing first signal measurements of RSs received over the first set of one or more RS occasions;
performing second signal measurements of RSs received over the second set of RS occasions; and
providing the first signal measurements identified as a first type of signal measurements and the second signal measurements identified as a second type of signal measurements for training a neural network (NN) for channel state information reference signal (CSI-RS) transmission or channel estimation.

28. The method of claim 27, wherein the configuration includes, for a given one of the RS resources, an indication of the first RS density and the second RS density, wherein the first RS density corresponds to a higher density than the second RS density.

29. A method for wireless communication at a network node, comprising:
transmitting a configuration indicating reference signal (RS) resources including at least a first set of one or more RS occasions of a first RS density and a second set of one or more RS occasions of a second RS density;
transmitting the RS over the first set of one or more RS occasions; and
transmitting the RS over the second set of one or more RS occasions.

30. The method of claim 29, wherein the configuration includes, for a given one of the RS resources, an indication of the first RS density and the second RS density, wherein the first RS density corresponds to a higher density than the second RS density.
